(19) United States
(12) Patent Application Publication
(10) Pub. No.: US 2024/0410718 A1
(43) Pub. Date: Dec. 12, 2024

(54) OPTICAL DETECTION OF THE OPENING OF A HOUSING

(71) Applicant: SAGEMCOM ENERGY & TELECOM SAS, BOIS-COLOMBES (FR)

(72) Inventors: Mickaël GOARANT, BOIS-COLOMBES (FR); Patrick WEBER, BOIS-COLOMBES (FR)

(21) Appl. No.: 18/732,115

(22) Filed: Jun. 3, 2024

(30) Foreign Application Priority Data
Jun. 7, 2023 (FR) FR2305742

(51) Int. Cl. G01D 4/02

(52) U.S. Cl. CPC G01D 4/02; G01D 2204/20

(57) ABSTRACT

A piece of equipment includes a housing in which there are incorporated an emitter emitting light signals, a receiver arranged to receive the light signals after they have been reflected against an inner wall of the housing, and a processing unit arranged to control the emitter so that it emits a detection light signal, oacquire a first electrical signal produced by the receiver when it receives the detection light signal, odetect, on the basis of a first level of the first electrical signal, whether the housing is open or closed.

The invention relates to the field of detecting the opening of a housing of a piece of equipment (which may be, but is not necessarily, a meter).

### BACKGROUND OF THE INVENTION

Some ill-intentioned people know techniques that enable them to open the housing of their meter and tamper with it in order to reduce the measurement of their consumption. This could affect any type of meter, for example an electricity meter, water meter, gas meter, etc.

A certain number of devices for detecting the opening of a meter housing are known.

In the case of water and gas meters, the detection device must consume very little electrical energy, because these meters are generally powered by a battery.

A detection device that is conventionally used comprises an electromechanical contact whose state changes when the housing is opened. However, water and gas meters are often filled with gel at the end of their manufacturing process. When it polymerises, this gel tends to block the electromechanical contact, rendering the detection device inoperative.

### OBJECT OF THE INVENTION

The object of the invention is to effectively detect the opening of the housing of a piece of equipment, without using electromechanical contact and with very low electrical energy consumption.

### SUMMARY OF THE INVENTION

In order to achieve this aim, a piece of equipment is proposed comprising a housing in which the following are incorporated:
an emitter arranged to emit light signals;

a receiver arranged to receive the light signals after they have been reflected against an inner wall of the housing;
a processing unit arranged to:
   control the emitter so that it emits a detection light signal;
   acquire a first electrical signal produced by the receiver when it receives the detection light signal;
   detect, on the basis of a first level of the first electrical signal, whether the housing is open or closed.

The detection, which is achieved by emitting, internally reflecting and capturing the detection light signal, is effective, simple and inexpensive to implement. The invention functions even when the housing is filled with gel. The components used consume very little electrical energy.

Also proposed is a piece of equipment as described above, in which the processing unit is arranged to:
acquire a second electrical signal produced by the receiver while the emitter is switched off;
detect the opening or closing of the housing on the basis of a value representative of a difference or a ratio between the first level of the first electrical signal and a second level of the second electrical signal.

Also proposed is a piece of equipment as described above, in which the housing comprises a first housing part, which is removable, the inner wall being a wall of the first housing part, and in which the emitter and the receiver are both positioned:
opposite and in the vicinity of the first housing part; or
opposite and in the vicinity of a second housing part of the housing, which is transparent or translucent to light signals, and positioned between the first housing part, and the emitter and the receiver.

Also proposed is a piece of equipment as described above, further comprising:
a first optical guide positioned between the emitter and the inner wall, and arranged to guide and concentrate the light signals towards the inner wall;
a second optical guide positioned between the receiver and the inner wall, and arranged to guide and concentrate the light signals towards the receiver.

Also proposed is a piece of equipment as described above, in which the first optical guide and the second optical guide are manufactured as a single part.

Also proposed is a piece of equipment as described above, further comprising a masking device comprising a first portion delimiting an inner space in which the receiver is positioned, and arranged to prevent spurious light signals originating from inside or outside the housing from interfering with the receiver.

Also proposed is a piece of equipment as described above, in which the masking device also comprises a second portion situated between the emitter and the receiver, and arranged to prevent spurious reflections, resulting from the reflection of the light signals emitted by the emitter on the first optical guide or on the second optical guide, or from lateral radiation originating from the emitter, from interfering with the receiver.

Also proposed is a piece of equipment as described above, in which the inner wall is made from injection-moulded plastic with a mirror finish.

Also proposed is a piece of equipment as described above, in which the inner wall has the shape of a concave reflector.

Also proposed is a piece of equipment as described above, comprising a reflective material chemically deposited on the inner wall.

Also proposed is a piece of equipment as described above, comprising a self-adhesive reflective label stuck to the inner wall.

Also proposed is a piece of equipment as described above in which the colour of the inner wall has a wavelength λ1 such that:

$$λ 1 = λ 2 \pm 10 \% ,$$

where λ2 is a wavelength of the light signals.

Also proposed is a piece of equipment as described above, the emitter and the receiver being arranged to respectively emit and receive light signals that are non-visible signals.

Also proposed is a piece of equipment as described above, the equipment being a fluid meter.

Also proposed is a detection method, implemented in the processing unit of a piece of equipment as described above, and comprising a detection phase comprising the steps of:
controlling the emitter so that it emits a detection light signal;
acquiring a first electrical signal produced by the receiver when it receives the detection light signal;
detecting, on the basis of a first level of the first electrical signal, whether the housing is open or closed.

Also proposed is a detection method as described above, implemented in the processing unit of a piece of equipment as described above, in which the detection phase further comprises the steps of:
acquiring a second electrical signal produced by the receiver while the emitter is deactivated;
detecting the opening or closing of the housing on the basis of a value representative of a difference or a ratio between the first level of the first electrical signal and a second level of the second electrical signal.

Also proposed is a detection method as described above, comprising the steps of:
repeating the detection phase;
when a detection phase is complete, defining a random time period, and starting a subsequent detection phase after the random time period.

Also proposed is a computer program comprising instructions which cause the processing unit of the electrical equipment as described above to perform the steps of the detection method as described above.

Also proposed is a computer-readable storage medium on which the computer program as described above is stored.

The invention will be best understood in the light of the following description of particular non-limiting embodiments of the invention.

### BRIEF DESCRIPTION OF THE DRAWINGS

Reference will be made to the accompanying drawings, in which:

FIG. 1 shows a simplified section view, along a vertical plane, of a fluid meter;

FIG. 2 shows steps of the detection method.

### DETAILED DESCRIPTION OF THE INVENTION

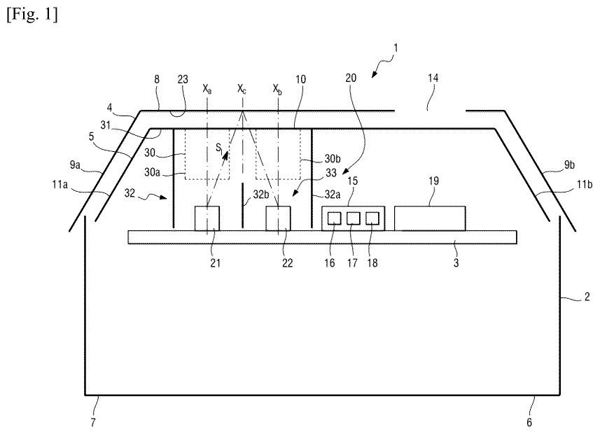

In reference to FIG. 1, a fluid meter 1 (for example a water or gas meter) is intended to measure the fluid consumption of a user's (customer's) installation. The fluid is supplied to the installation by a distribution network.

The meter 1 comprises a housing 2 and a printed circuit board 3.

The housing 2 in this case comprises a first housing part 4, a second housing part 5 and a frame 6.

The frame 6 comprises a bottom face 7 that is also the bottom face of the housing 2.

The first housing part 4 comprises a top face 8 that is also the top face of the housing 2, a first lateral face 9a and a second lateral face 9b. The first housing part 4 is removable. It may be removed by an operator working, for example, for the fluid distributor or for the manager of the distribution network. The first housing part 4 is opaque to visible light (as is the frame 6).

The second housing part 5 is transparent or translucent to visible light. It is fitted inside the housing 2, i.e., between the first housing part 4 and the inside of the meter 1. It comprises a top face 10, a first lateral face 11a and a second lateral face 11b, which are positioned parallel to, opposite to and in the vicinity of the top face 8, the first lateral face 9a and the second lateral face 9b of the first housing part 4, respectively.

The top face 8 of the first housing part 4 comprises an aperture 14. Light from outside can therefore enter the interior of the meter 1 via this aperture 14 and the second housing part 5.

The printed circuit board 3 of the meter 1 is positioned parallel to and in the vicinity of the top face 10 of the second housing part 5 (and therefore the top face 8 of 20 the first housing part 4).

The printed circuit board 3 first comprises a processing unit 15.

The processing unit 15 comprises at least one processing component 16, which is, for example, a “general-purpose” processor, a processor specialising in signal processing (or digital signal processor (DSP)), a microcontroller, or a programmable logic circuit, such as an FPGA (or field-programmable gate array) or an ASIC (or application-specific integrated circuit). In this instance, the processing component 16 is a microcontroller.

The processing unit 15 also comprises one or more memories 17 connected to or integrated into the microcontroller 16. At least one of these memories 17 forms a computer-readable storage medium on which at least one computer program is stored comprising instructions which cause the microcontroller 16 to perform at least some of the steps of the detection method described below.

The processing unit 15 also comprises an analogue-to-digital converter (ADC) 18, possibly (but not necessarily) integrated into the microcontroller 17.

The printed circuit board 3 also comprises an LCD screen 19, which is positioned facing the aperture 14, enabling the user to see the screen 19 through the aperture 14 and the second housing part 5.

The meter 1 also comprises a detection device 20 for detecting the opening of the housing 1.

In this instance, the detection device 20 comprises the processing unit 15 and, in particular, the microcontroller 16 and the ADC 18. This does not prevent the processing unit 16 from having functions other than this, for example metrology (measurement of fluid consumption) functions.

The detection device 20 also comprises an emitter 21 and a receiver 22 fitted to the printed circuit board 3.

The emitter 21 is arranged to emit light signals, and the receiver 22 is arranged to receive the light signals after they have been reflected against an inner wall 23 of the housing 1. “Inner” should be understood to mean on the inside of the meter 1.

This inner wall 23 is the inner wall of the top face 8 of the first housing part 4. The light signals emitted by the emitter 21 therefore pass through the second housing part 5, are reflected by the inner wall 23, and are then captured by the receiver 22.

The emitter 21 is in this instance a light-emitting diode (LED) and the receiver 22 is in this instance a phototransistor.

The LED 21 and the phototransistor 22 are in this instance both positioned opposite and in the vicinity of the top face 10 of the second housing part 5 of the housing 2, which is therefore itself positioned between the first housing part 4, and the LED 21 and the phototransistor 22.

The portion of the top face 10 of the second housing part 5, opposite which the LED 21 and the phototransistor 22 are positioned, is itself positioned opposite a portion of the first housing part 4 that is a “solid” portion (and not opposite the aperture 14).

In this instance, the LED 21 and the phototransistor 22 are positioned 5 mm apart from one another, and at a distance of 1 cm from the inner wall 23 of the first housing part 4.

The principle of the invention will be explained first. It is intended to detect whether the housing 2 is open or closed and therefore, in this instance, more specifically, to detect whether the first housing part 4 has been opened (i.e., whether at least one of its ends has been moved away from the rest of the housing 2).

The detection is based on measuring the optical reflections of a light signal emitted by the LED 21 and then reflected on the inner wall 23 of the housing 2, and finally captured by the phototransistor 22.

If the first housing part 4 is missing or has been separated, the optical reflections are limited, causing the signal level in the phototransistor 22 to drop. This drop can be detected.

The processing unit 15 is therefore arranged to:
control the LED 21 (i.e., switch it on) so that it emits a detection light signal Sₗ;
when the LED 21 is switched on, acquire a first electrical signal produced by the phototransistor 22 when it receives the detection light signal Sₗ;
detect, on the basis of a first level of the first electrical signal, whether the housing 2 is open or closed;
switch off the LED 21 (this step may be carried out before the previous one).

It should be noted that, in this instance, the emission of the detection light signal Sₗ consists merely in switching the LED 21 on. The reception of the detection light signal Sₗ is the capture by the phototransistor 22 of the light flux emitted by the LED 21 and reflected by the inner wall 23 (and by other walls of the housing 2, if applicable).

The first electrical signal is in this instance a first voltage V₁ produced by the phototransistor 22. The first level is the amplitude of the first voltage V₁.

The first voltage V₁ is an analogue voltage.

The first voltage V₁ is digitized by the ADC 18 to produce a digital signal.

This configuration is not compulsory; the receiver could in particular be a “digital” sensor.

The microcontroller 16 detects whether the housing 2 is open or closed on the basis of the first voltage V₁.

In order to improve detection performances, the light energy is measured while the LED 21 is switched on (as just described), then the light energy is measured without the LED 21 being switched on.

The order in which the two measurements are taken is irrelevant.

The processing unit 15 therefore acquires a second electrical signal produced by the phototransistor 22 while the LED 21 is switched off (i.e., while it is not emitting light), and detects the opening or closing of the housing 2 based not only on the first level of the first electrical signal (amplitude of the first voltage V₁), but on the basis of a value representative of a difference or a ratio between the first level and a second level of the second electrical signal.

The second electrical signal is a second voltage V₂ produced by the phototransistor 22. The second level is the amplitude of the second voltage V₂.

The second voltage V₂ is an analogue voltage, digitized by the ADC 18.

Therefore, analysing the difference in illumination at the receiver 22, and the electrical signals (first voltage V₁ and second voltage V₂) that it generates, makes it possible to eliminate the interferences that would be produced by:
a light ray from outside meter 1 which “simulates” the LED 21;
a light ray from outside meter 1 which saturates the phototransistor 22.

In the nominal case, with the housing 2 closed, the difference in brightness, measured by the phototransistor 22 with the LED 21 switched on and without the LED 21 switched on, is high. Indeed, a very large portion of the light flux emitted by the LED 21 is captured by the phototransistor 22.

However, if the housing 2 is open, the light flux is not reflected by the inner wall 23 of the first housing part 4, which has been removed. Therefore, the difference between the two measurements is clearly smaller. Naturally, if the housing 2 is not completely open and if the first housing part 4 is still present, being partially open, the light flux is still partially reflected by the inner wall 23, but to a lesser extent, which means that this partial opening can also be detected.

The invention functions very effectively regardless of the ambient light outside the meter 1:
either ambient light is present, and the difference between the two measurements reduces because the phototransistor 22 is illuminated by the ambient light;
or there is no ambient light, and it is the absence or reduction of reflections on the first housing part 4, now removed, which reduces this difference between the two measurements.

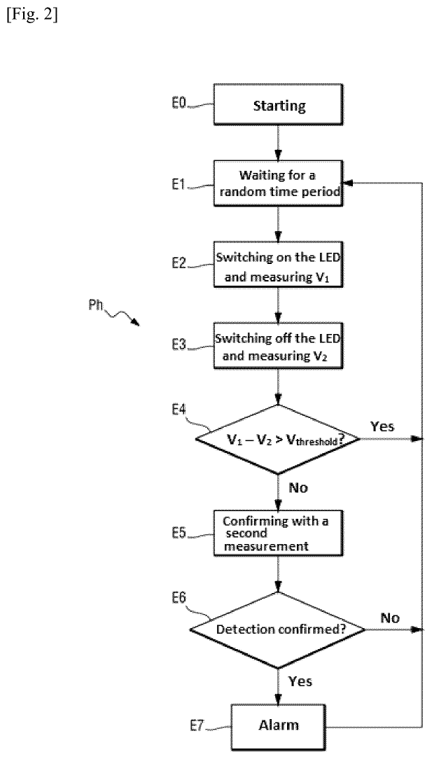

The detection method implemented by the processing unit 15 is now described in more details in reference to FIG. 2.

The method starts with a starting step: step E0.

The method comprises detection phases Ph which are repeated continuously from the time the meter 1 is initially powered up.

When a detection phase is completed, the processing unit 15 defines a random time period, and waits for a time equal to the random time period: step E1.

This random time period is “drawn at random” after each detection phase.

This ensures that it is impossible for a potential fraudster to predict the start of the detection phases Ph. In this way, an attempt to defraud the system by emitting a light signal similar to that emitted by the LED 21 is prevented.

In this instance, the random time period is bounded between a minimum time period, for example equal to 5 seconds, and a maximum time period, for example equal to 5 minutes.

The values of the random time period are in this instance distributed in a uniform manner, but another distribution, for example a Gaussian or lognormal distribution, is possible.

After the step E1, the detection phase Ph begins.

The processing unit 15 switches on the LED 21, which emits a detection light signal Sₗ. The processing unit 15 acquires the first voltage V₁ produced by the phototransistor 22 when it receives the first detection light signal Sₗ: step E2.

Next, the processing unit 15 switches off the LED 21, and acquires the second voltage V₂ produced by the phototransistor 22: step E3.

As mentioned above, the order of the two steps E2 and E3 may be switched.

The processing unit 15 detects the opening or closing of the housing 2 on the basis of a value representative of a difference or a ratio between the first level of the first electrical signal (V₁) and the second level of the second electrical signal (V₂).

In this instance, the processing unit 15 checks whether:

$${V}_{1} - {V}_{2} > {V}_{threshold}$$

where V₁ is the first voltage, V₂ is the second voltage, and V_{threshold} is a predetermined voltage threshold (for example equal to 0.4 V): step E4.

If this is the case, the processing unit 15 deduces that the housing 2 is indeed closed. The detection phase ends and the method returns to the step E1.

If V₁−V₂≤V_{threshold}
the processing unit 15 detects an opening of the housing 2.

The processing unit 15 confirms this result with a second measurement (i.e., it repeats the steps E2, E3 and E4): step E5.

The processing unit 15 checks whether or not the detection of the opening of the housing 2 is confirmed: step E6.

If the detection of the opening of the housing 2 is not confirmed, the detection phase ends and the method returns to the step E1.

Otherwise, the processing unit 15 records the information that the housing 2 is open, produces an alarm message and transmits it to the fluid distributor and/or the network manager: step E7.

Previous measurements can be reused by filtering out non-standard measurements and averaging in order to change the predetermined voltage threshold V_{threshold}. The predetermined voltage threshold V_{threshold} is therefore then a dynamic threshold.

The predetermined voltage threshold V_{threshold} is, for example, defined on the basis of the history of previous measurements.

For example:

$${V}_{threshold} = ( {Moy\_V}_{1} - {Moy\_V}_{2} ) / 2 ,$$

where Moy_V₁ is the average of the values of V₁ of the first and third quartile and Moy_V₂ is the average of the values of V₂ of the first and third quartile.

Advantageously, one or more optical guides 30 are added in the housing 2 to keep the light beam concentrated and allow it to be reflected in its entirety on the housing 2.

In this instance, the meter 1 comprises a first optical guide 30a positioned between the LED 21 and the inner wall 23, and arranged to guide and concentrate the light signals towards the inner wall 23. The meter 1 also comprises a second optical guide 30b positioned between the phototransistor 22 and the inner wall 23, and arranged to guide and concentrate the light signals towards the phototransistor 22.

The first optical guide 30a is in the form of a cylinder whose axis Xₐ extends vertically relative to the board 3 from the LED 21. The axis Xₐ is perpendicular to the printed circuit board 3, to the top face 10 of the second housing part 5 and to the top face 8 of the first housing part 4.

The second optical guide 30b is in the form of a cylinder whose axis X_{b} extends vertically relative to the board 3 from the phototransistor 22. The axis X_{b} is perpendicular to the printed circuit board 3, to the top face 10 of the second housing part 5 and to the top face 8 of the first housing part 4.

The first optical guide 30a and the second optical guide 30b extend vertically and perpendicularly from the inner wall 31 of the top face 10 of the second housing part 5.

In this instance, the first optical guide 30a and the second optical guide 30b are manufactured as a single part.

It should be noted that the meter 1 also comprises a guiding device, which is not shown, which directs the light beam from the outlet of the first optical guide 30a to the inlet of the second optical guide 30b.

The meter 1 also comprises a masking device 32.

The masking device 32 comprises a first portion 32a and a second portion 32b.

The first portion 32a delimits an inner space 33 in which the receiver 22 (or, at the very least, its sensitive cell) is positioned. The first portion 32a prevents spurious light signals, from inside or outside the housing 2, from interfering with the receiver 22.

The first portion 32a is in the form of a cylinder and has an axis X_{c}, perpendicular to the printed circuit board 3, to the top face 10 of the second housing part 5 and to the top face 8 of the first housing part 4. In this instance, the axis X_{c} passes through a point situated in the middle of the segment linking the LED 21 and the phototransistor 22.

The first portion 32a extends vertically and perpendicularly from the inner wall 31 of the top face 10 of the second housing part 5.

The free end of the first portion 32a is very close to (or even in contact with) the printed circuit board 3.

The masking device 32 also comprises a second portion 32b.

The second portion 32b is situated between the emitter 21 and the receiver 22. It prevents spurious reflections, resulting from the reflection of the light signals emitted by the emitter 21 on the first optical guide 30a or on the second optical guide 30b, or from lateral radiation originating from the emitter 21, from interfering with the receiver 22.

The second portion 32b is a straight partition that extends vertically and perpendicularly from the printed circuit board 3. The height of this partition extends along the axis X_{c}, and is such that the top of the partition is positioned along the axis Xe close to (or even above) the free end of the optical guides 30a, 30b.

The emitter 21 and the receiver 22 can be arranged to respectively emit and receive light signals that are non-visible signals, i.e., that are produced by emitting light with a wavelength in the non-visible spectrum.

This prevents a potential fraudster from seeing that the detection method is implemented in the meter 1, even if the housing 1 comprises a face that is transparent or translucent to visible light (like the second housing part 5) that light signals emitted by the LED 21 could pass through.

Moreover, a light with a wavelength different from those of the lights normally present in the vicinity of the meter 1 may be chosen in order not to interfere with the detection device 20. Therefore, the light is an infrared light, for example.

It is also possible to choose a light that is more difficult for a potential fraudster to reproduce, for example a blue light.

The meter 1 may also comprise a plurality of emitters 21 generating lights of different wavelengths, which are activated alternately in order to ensure that the source is not reproduced by a potential fraudster.

The inner wall 23 of the first housing part 4 may be designed to improve the reflections.

The inner wall 23 may be shaped like a concave reflector.

Therefore, the surface of the inner wall 23 is adapted to fit a concave reflector there (during plastic injection moulding, for example) which will concentrate the light rays from the LED 21, reflecting them towards the phototransistor 22.

The inner wall 23 may be made from injection-moulded plastic with a mirror finish (surface state) in order to reflect the light signals emitted by the LED 21 as effectively as possible.

It is possible, while manufacturing the first housing part 4, to chemically deposit a reflective material on the inner wall 23, for example by screen printing, ink spray or paint spray.

The first housing part 4 may comprise a self-adhesive reflective label stuck to the inner wall 23. The self-adhesive label is selected for its reflective properties and durability.

The colour of the inner wall 23 may be of a wavelength close to the light wavelength of the internal light source (for example, green if the light source is green).

For example, the colour of the inner wall 23 has a wavelength λ1 such that:

λ1=λ2±10%,
where λ2 is a wavelength of the light signals emitted by the emitter 21 (i.e., of the light produced by the emitter 21).

The measurements without and with the light source (i.e., steps E2 and E3) can also be taken closer together in time, so as not to be affected by the ambient lighting (50 or 60 Hz) of compact fluorescent tubes.

The invention offers many advantages.

It functions both when there is transparent resin or gel in the meter 1, but also without resin or gel: as described above, unlike devices comprising an electromechanical contact, the invention functions effectively even when resin or gel is present.

The detection device 20 consumes very little electrical energy. The device 20 consumes little current because it is activated for a very short time and switched off for random periods of time that are much longer. This limits the possible deterioration in the reliability of the optical components. The device 20 is ideally suited to battery-powered equipment (for example, the meter 1).

The power consumption of the device 20 (LED 21, phototransistor 22, ADC 18 and microcontroller 16) is approximately 0.5 mA on average for 1 ms, i.e., 0.5 μAsec. As the duration of a detection phase Ph is at least 5 seconds, the power consumption is 0.1 μAsec, and therefore totally negligible.

The device 20 is very simple to implement and is inexpensive. The components used (for example, the LED 21 and the phototransistor 22) are standard components that do not need to be high-speed or sensitive.

The device 20 is easily adaptable and can be installed on existing products without modification.

The device 20 is very sensitive. The device 20 is capable of detecting minimal opening of the housing 2. It can even detect water infiltration between the housing 2 and the potting gel or between the first housing part 4 and the second housing part 5 due to the effect of water on the light rays.

The device 20 is robust against electronic interference, making it difficult for fraudsters to interfere with, and enabling it to be used in complex electromagnetic environments.

The device 20 allows all necessary measures to be taken, such as deleting keys, raising an alarm and/or transmitting this alarm to the surveillance network.

This is a simple, low-energy solution that can easily be adapted to the mechanical dimensions of all products.

The device 20 helps to overcome attempts at fraud. It is therefore capable of thwarting attempts to open the product in an illuminated room or in total darkness.

Naturally, the invention is not limited to the embodiments described, but covers any variant coming within the ambit of the invention as defined by the claims.

The equipment in which the invention is implemented is not necessarily a fluid meter. It may be any type of meter and even, more generally, any type of equipment.

The emitter is not necessarily an LED, but could be any type of photoemitter, for example a laser diode.

The receiver is not necessarily a phototransistor, but could be any type of photoreceptor, for example a photodiode.

The electrical architecture used could be different to that described herein. For example, the emitter and the receiver could be integrated into the same component, directly into a housing part, etc. Not all of the electrical components are necessarily mounted on the same board.

The housing may be different to that described here. The second housing part is optional. Moreover, the housing does not necessarily comprise a removable housing part (such as the first housing part), and the detection device could detect that the housing has been opened by breaking it.

If the housing does not comprise the second housing part, the emitter and the receiver can be positioned opposite and in the vicinity of the first housing part.

In this instance, the detection is carried out on the basis of a value representative of a difference or a ratio between the first level of the first electrical signal and the second level of the second electrical signal. This value is therefore not necessarily equal to the difference between the first level of the first electrical signal and the second level of the second electrical signal. For example, it could be a difference between the second level and the first level, or a ratio between the first level and the second level, or a ratio between the second level and the first level, etc.

1. A piece of equipment comprising a housing in which the following are incorporated:
an emitter arranged to emit light signals;
a receiver arranged to receive the light signals after they have been reflected against an inner wall of the housing;
a processing unit arranged to:
control the emitter so that it emits a detection light signal;
acquire a first electrical signal produced by the receiver when it receives the detection light signal;
detect, on the basis of a first level of the first electrical signal, whether the housing is open or closed,
the processing unit being further arranged to: acquire a second electrical signal produced by the receiver while the emitter is switched off;
detect the opening or closing of the housing on the basis of a value representative of a difference or a ratio between the first level of the first electrical signal and a second level of the second electrical signal.

2. The piece of equipment according to claim 1, wherein the housing comprises a first housing part, which is removable, the inner wall being a wall of the first housing part, and wherein the emitter and the receiver are both positioned:
opposite and in the vicinity of the first housing part; or
opposite and in the vicinity of a second housing part of the housing, which is transparent or translucent to light signals, and positioned between the first housing part, and the emitter and the receiver.

3. The piece of equipment according to claim 1, further comprising:
a first optical guide positioned between the emitter and the inner wall, and arranged to guide and concentrate the light signals towards the inner wall;
a second optical guide positioned between the receiver and the inner wall, and arranged to guide and concentrate the light signals towards the receiver.

4. The piece of equipment according to claim 3, wherein the first optical guide and the second optical guide are manufactured as a single part.

5. The piece of equipment according to claim 1, further comprising a masking device comprising a first portion delimiting an inner space in which the receiver is positioned, and arranged to prevent spurious light signals originating from inside or outside the housing from interfering with the receiver.

6. The piece of equipment according to claim 5, further comprising:
a first optical guide positioned between the emitter and the inner wall, and arranged to guide and concentrate the light signals towards the inner wall;
a second optical guide positioned between the receiver and the inner wall, and arranged to guide and concentrate the light signals towards the receiver, wherein the masking device also comprises a second portion situated between the emitter and the receiver, and arranged to prevent spurious reflections, resulting from the reflection of the light signals emitted by the emitter on the first optical guide or on the second optical guide, or from lateral radiation originating from the emitter, from interfering with the receiver.

7. The piece of equipment according to claim 1, wherein the inner wall is made from injection-moulded plastic with a mirror finish.

8. The piece of equipment according to claim 1, wherein the inner wall has the shape of a concave reflector.

9. The piece of equipment according to claim 1, comprising a reflective material chemically deposited on the inner wall.

10. The piece of equipment according to claim 1, comprising a self-adhesive reflective label stuck to the inner wall.

11. The piece of equipment according to claim 1, wherein the colour of the inner wall has a wavelength λ1 such that:
$$λ 1 = λ 2 \pm 10 \% ,$$
where λ2 is a wavelength of the light signals.

12. The piece of equipment according to claim 1, wherein the emitter and the receiver are arranged to respectively emit and receive light signals that are non-visible signals.

13. The piece of equipment according to claim 1, wherein the equipment is a fluid meter.

14. A detection method, implemented in the processing unit of the piece of equipment according to claim 1, and comprising a detection phase comprising the steps of:
controlling the emitter so that it emits a detection light signal;
acquiring a first electrical signal produced by the receiver when it receives the detection light signal;
detecting, on the basis of a first level of the first electrical signal, whether the housing is open or closed.

15. The detection method according to claim 14, wherein the detection phase further comprises the steps of:
acquiring a second electrical signal produced by the receiver while the emitter is deactivated;
detecting the opening or closing of the housing on the basis of a value representative of a difference or a ratio between the first level of the first electrical signal and a second level of the second electrical signal.

16. The detection method according to claim 14, comprising the steps of:
repeating the detection phase;
when a detection phase is complete, defining a random time period, and starting a subsequent detection phase after the random time period.

17. (canceled)

18. A non-transitory computer-readable storage medium on which a computer program is stored, wherein the computer program comprises instructions that cause the processing unit of the electrical equipment according to claim 1 to perform a detection method, implemented in the processing unit of the piece of equipment, and comprising a detection phase comprising the steps of:
controlling the emitter so that it emits a detection light signal;
acquiring a first electrical signal produced by the receiver when it receives the detection light signal;
detecting, on the basis of a first level of the first electrical signal, whether the housing is open or closed.
